(19) United States
(12) Patent Application Publication
(10) Pub. No.: US 2014/0290315 A1
(43) Pub. Date: Oct. 2, 2014

(54) PULLING LOCKING DEVICE

(71) Applicants: JIN TAY INDUSTRIES CO., LTD., New Taipei City (TW); SIMON LOCK CO., LTD., Taipei City (TW)

(72) Inventor: Kuo-Tsung YANG, Taipei City (TW)

(21) Appl. No.: 14/304,739

(22) Filed: Jun. 13, 2014

Related U.S. Application Data
(63) Continuation-in-part of application No. 13/631,059, filed on Sep. 28, 2012.

(51) Int. Cl. E05B 73/00; E05B 65/00; E05B 37/02

(52) U.S. Cl. CPC E05B 73/00; E05B 37/02; E05B 65/00
USPC 70/58

(57) ABSTRACT

A pulling locking device has a cord, a lock module, an engaging seat and a mounting seat. The lock module, the engaging seat and the mounting seat are mounted around the cord. The lock module has a lock casing, a lock core and a sliding element. The sliding element is slidable relative to the lock casing to selectively engage with the engaging seat only when the lock core is unlocked. When the pulling locking device is in use, a portable electronic device is clamped between the engaging seat and the mounting seat. With the cooperation of the lock module and the engaging seat, the portable electronic device can be fixed in position without any further structural design particularly for the locking device, which lowers the manufacturing cost, and enables the pulling lock device to be adapted for various kinds of portable electronic devices.

### CROSS-REFERENCE TO RELATED APPLICATIONS

This application is a continuation in part application of United States patent application filed on Sep. 28, 2012 and having application Ser. No. 13/631,059, the entire contents of which are hereby incorporated herein by reference.

### BACKGROUND OF THE INVENTION

1. Field of the Invention

The present invention relates to a locking device, especially to a pulling locking device for locking a portable electronic product.

2. Description of the Prior Arts

Nowadays information is transmitted fast, and most consumers collect information about the product before purchasing. Therefore, there are more and more shopping venues with open display without clerks directly assisting with demonstrating of the products. However, it is hard to prevent the products on display from shoplifting. In particular, portable electronic products are getting compact in size and light-weighted, which makes shoplifting easier. Thus, the conventional mode for merchandise display is not safe enough.

To raise the safety, the products may be locked with a locking device. The conventional locking device is connected with a cord or a rope. The cord or the rope is fixed at a display position. The portable electronic device has a threaded hole for the locking device to be fastened thereto. Thus, the portable electronic device is fixed in position by the cord or the rope. However, the conventional locking device is only adapted for portable electronic device with a threaded hole, or the portable electronic device has to be further processed, such as being drilled with a threaded hole, to be adapted to the locking device, which is very inconvenient.

To overcome the shortcomings, the present invention provides a pulling locking device to mitigate or obviate the aforementioned problems.

### SUMMARY OF THE INVENTION

The main objective of the present invention is to provide a pulling locking device that can be adapted for portable electronic devices of various types.

The pulling locking device has a cord, a lock module, an engaging seat, a mounting seat and a fixing nut. The lock module is mounted around the cord, and has a lock casing, a lock core, a sliding element and a resilient element. The lock casing is mounted around the cord and has an assembling end. The lock core is mounted in the lock casing, and has an actuating element. The sliding element is selectively slidably mounted in the lock casing. When the lock core is locked, the actuating element abuts the sliding element to prevent the sliding element from sliding relative to the lock casing. When the lock core is unlocked, the actuating element departs from the sliding element to make the sliding element slidable relative to the lock casing. The resilient element is clamped between an inner wall of the lock casing and the sliding element. The engaging seat is mounted around the cord, is disposed adjacent to the lock module, and has a first side, a second side, an engaging member and a clamp member. The first side is toward the assembling end of the lock casing. The engaging member is disposed on the first side of the engaging seat, selectively makes the engaging seat engage with the cord, and selectively engages with the sliding element of the lock module. The clamp member of the engaging seat is disposed on the second side of the engaging seat. The mounting seat is mounted around the cord, and has a clamp member and a cord hole. The cord hole is mounted around the cord. The fixing nut is mounted around and screwed on an end of the cord.

When the pulling locking device is in use, a portable electronic device is clamped between the engaging seat and the mounting seat. With the cooperation of the lock module and the engaging member, the portable electronic device can be fixed in position without any further structural design adapted for the locking device, which lowers the manufacturing cost, and enables the pulling lock device to be adapted for various kinds of portable electronic devices.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a pulling locking device in accordance with the present invention;

FIG. 2 is an exploded perspective view of the pulling locking device in FIG. 1;

FIG. 3 is an enlarged partial side view of the pulling locking device in FIG. 1;

FIG. 4 is an enlarged side view in partial section of the pulling locking device in FIG. 1, showing an engaging seat unengaged;

FIG. 5 is an enlarged side view in partial section of the pulling locking device in FIG. 1, showing the engaging seat engaged;

FIG. 6 is an enlarged side view of the pulling locking device in FIG. 1, showing a lock module and the engaging seat when the lock module is unlocked;

FIG. 7 is an enlarged side view of the pulling locking device in FIG. 1, showing the lock module and the engaging seat when the lock module is locked;

FIG. 8 is a perspective view of a pulling locking device of another embodiment in accordance with the present invention;

FIG. 9 is an enlarged side view of the pulling locking device in FIG. 1, showing the lock module and the engaging seat when the lock module is locked;

FIG. 10 is an enlarged side view of the pulling locking device in FIG. 1, showing the lock module and the engaging seat when the lock module is unlocked;

FIG. 11 is a perspective view of a pulling locking device of still another embodiment in accordance with the present invention;

FIG. 12 is a perspective view of a mounting seat of the pulling locking device in FIG. 1; and

FIG. 13 is a perspective view of the mounting seat of a pulling locking device of further another embodiment in accordance with the present invention.

### DETAILED DESCRIPTION OF THE PREFERRED EMBODIMENTS

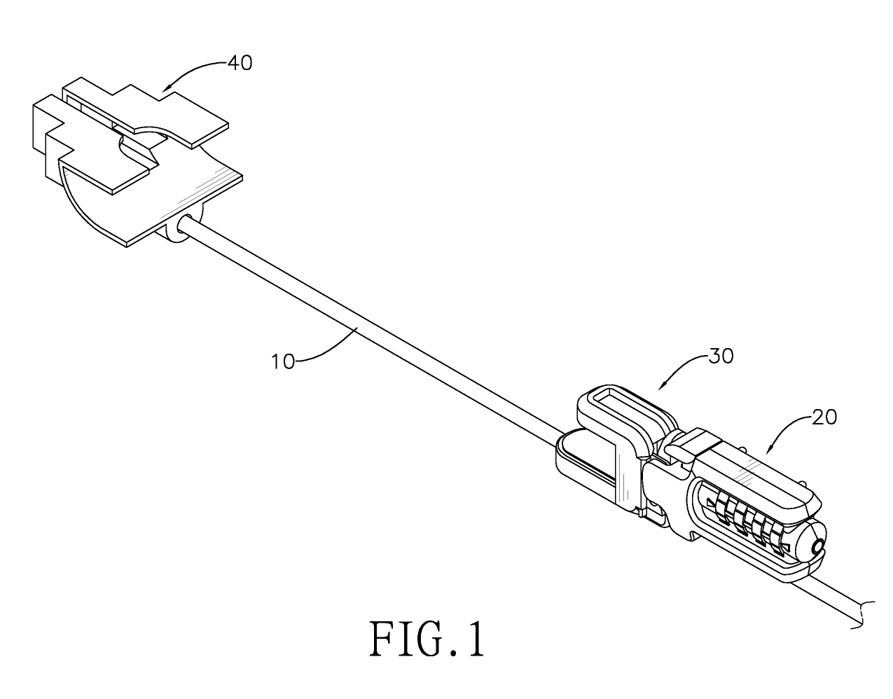

With reference to FIG. 1, a pulling locking device in accordance with the present invention comprises a cord 10, a lock module 20, an engaging seat 30, and a mounting seat 40.

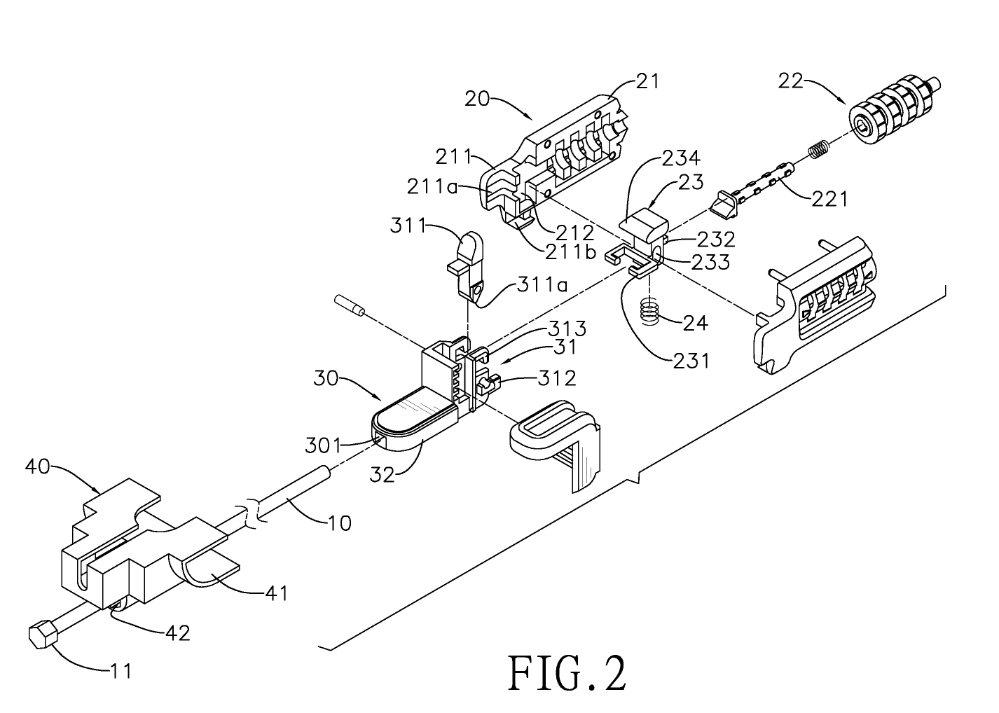

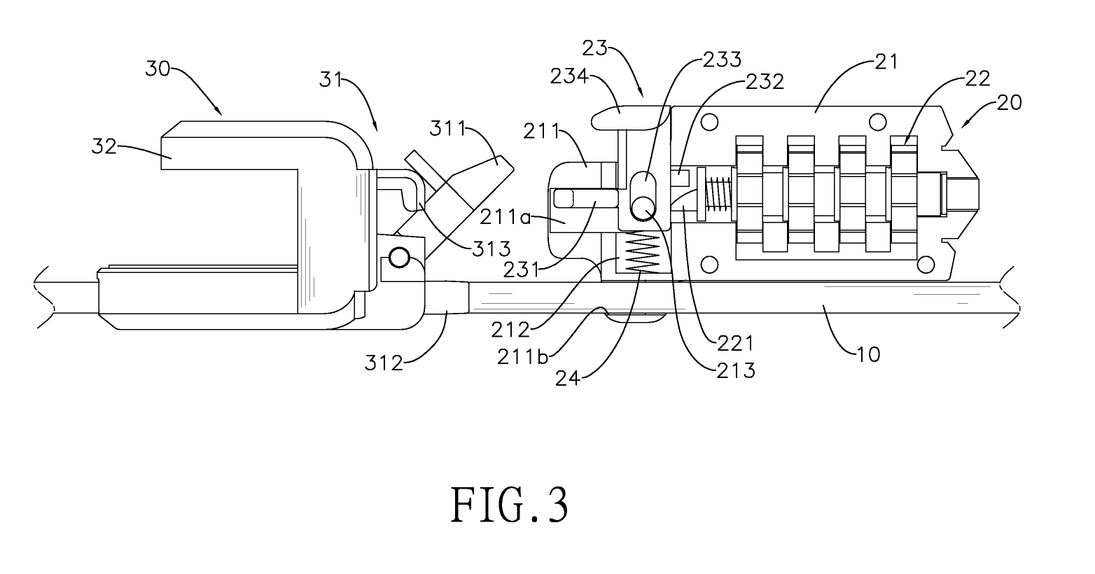

With reference to FIGS. 2 and 3, the lock module 20 is mounted around the cord 10, and has a lock casing 21, a lock core 22, a sliding element 23 and a resilient element 24.

The lock casing 21 is mounted around the cord 10 and has an assembling end 211, an engaging opening 211a, a mounting hole 211b, an inner space 212 and a positioning pin 213. The engaging opening 211a is formed in the assembling end 211. The mounting hole 211b is formed in the assembling end 211, does not communicate with the engaging opening 211a, and is disposed around the cord 10. The inner space 212 is disposed adjacent to the assembling end 211 and communicates with the engaging opening 211a. The positioning pin 213 is formed in the inner space 212.

The lock core 22 is mounted in the lock casing 21 and has an actuating element 221. The lock core 22 may be in various forms, such as a combination lock or a cam lock. Details of the structure of the lock core 22 are ordinary skill in the art, and thus are not described here.

The sliding element 23 is selectively slidably mounted in the inner space 212 of the lock casing 21. When the lock core 22 is locked, the actuating element 221 abuts the sliding element 23 to prevent the sliding element 23 from sliding relative to the lock casing 21. When the lock core 22 is unlocked, the actuating element 221 departs from the sliding element 23 to make the sliding element 23 slidable relative to the lock casing 21. The sliding element 23 has a stop segment 231, an abutting segment 232, an elongated hole 233 and a crown segment 234. The stop segment 231 is formed on an outer side of the sliding element 23 and extends into the engaging opening 211a of the lock casing 21. The sliding element 23 may be a C-clip. The abutting segment 232 is formed on an inner side of the sliding element 23 and selectively abuts the actuating element 221 of the lock core 22. The elongated hole 233 is formed through the sliding element 23. The positioning pin 213 of the lock casing 21 is mounted in the elongated hole 233 to restrict the sliding range of the sliding element 23. The crown segment 234 is disposed on an end of the sliding element 23 and protrudes out of the lock casing 21 to be conveniently pushed by a user.

The resilient element 24 is mounted in the inner space 212 of the lock casing 21, and is clamped between an inner wall of the lock casing 21 and the sliding element 23, thereby pushing the sliding element 23 back to the original position. The resilient element 24 may be a spring.

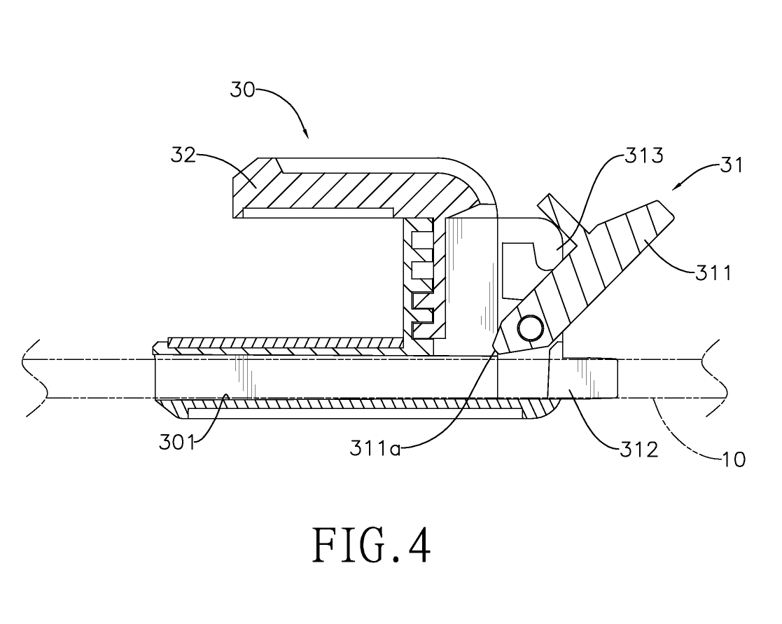

With reference to FIGS. 2 to 4, the engaging seat 30 is mounted around the cord 10, is disposed adjacent to the lock module 20, and has a first side, a second side, an engaging member 31 and a clamp member 32. The first side is toward the assembling end 211 of the lock casing 21. The engaging member 31 is disposed on the first side of the engaging seat 30, selectively makes the engaging seat 30 engage with any portion of the cord 10, and selectively engages with the sliding element 23 of the lock module 20. When the engaging member 31 and the sliding element 23 engage with each other and the lock core 22 is locked, the engaging seat 30 and the lock module 20 cannot be separated from each other, such that the engagement between the engaging member 31 and the cord 10 cannot be released. When the engaging member 31 and the sliding element 23 engage with each other but the lock core 22 is unlocked, the sliding element 23 can slide to disengage from the engaging member 31, such that the lock module 20 and the engaging seat 30 can be separated from each other to enable the engaging member 31 to disengage from the cord 10. In a preferred embodiment, the engaging seat 30 has a cord hole 301 disposed around the cord 10. The engaging member 31 has a pivot element 311, a mounting protrusion 312 and a stop segment 313. The pivot element 311 is pivotally connected to the first side of the engaging seat 30, and has a bottom end 311a selectively extending to the cord hole 301 of the engaging seat 30 to tightly press the cord 10. The mounting protrusion 312 corresponds to the mounting hole 211b of the lock casing 21. The stop segment 313 of the engaging member 31 corresponds to the stop segment 231 of the sliding member 23. The clamp member 32 is disposed on the second side of the engaging seat 30.

With reference to FIG. 2, the mounting seat 40 is mounted around the cord 10, and has a clamp member 41 and a cord hole 42. The cord hole 42 is disposed around the cord 10.

A fixing nut 11 is mounted around and is screwed on an end of the cord 10 to prevent the mounting seat 40 from axially separating from the cord 10. When the fixing nut 11 is rotated to separate from the cord 10, the mounting seat 40 may be separated from the cord 10 to be replaced by a mounting seat 40 of another type. The fixing nut 11 may be a non-circular nut such as a hex nut, and the cord hole 42 of the mounting seat 40 is a non-circular hole such as a hexagonal hole. The fixing nut 11 and the cord hole 42 of the mounting seat 40 correspond to each other in shape. When the mounting seat 40 is moved to the end of the cord 10, the fixing nut 11 engages in the cord hole 42 of the mounting seat 40 to prevent the fixing nut 11 from being rotated and separating from the cord 10, so as to prevent theft.

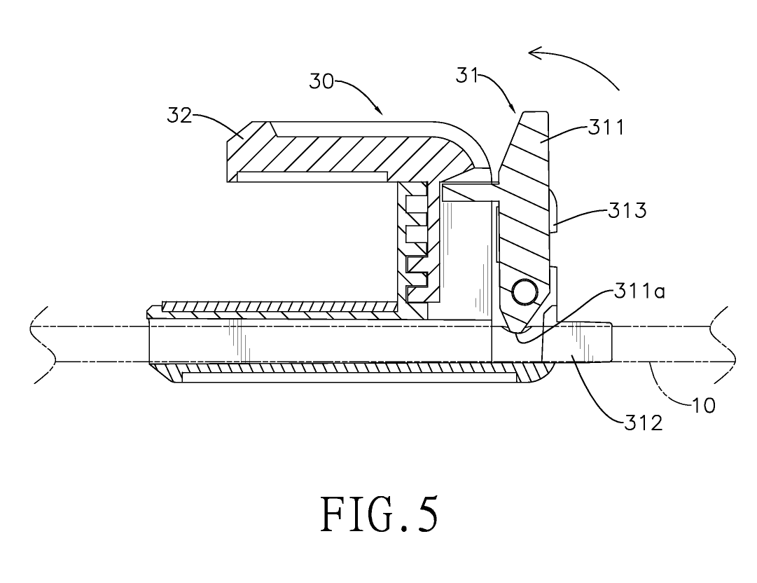

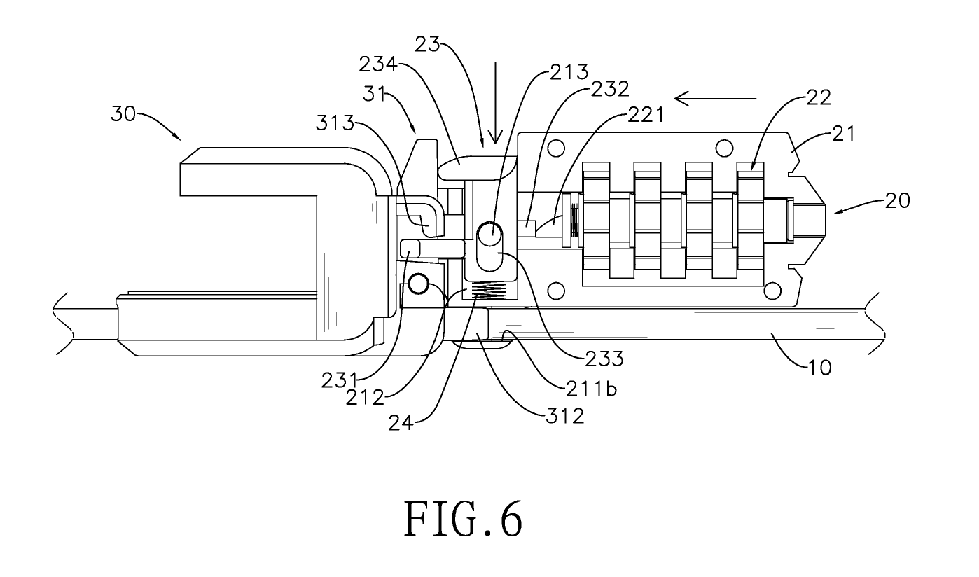

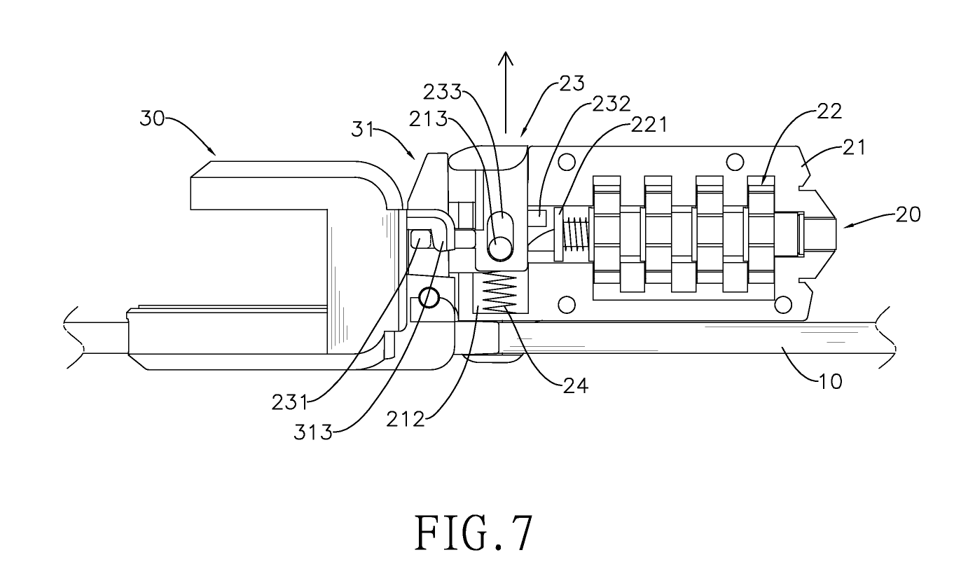

With reference to FIGS. 1 and 3, when the pulling locking device as described is in use, the mounting seat 40 is moved to the end of the cord 10 first. Then, a portable electronic device to be fixed is mounted between the engaging seat 30 and the mounting seat 40. Afterwards, the engaging seat 30 is moved until the portable electronic device is tightly clamped between the mounting seat 40 and the engaging seat 30. With reference to FIG. 5, the pivot element 311 is rotated to make the bottom end 311a engage with the cord 10, such that the engaging seat 30 engages with the cord 10 and is unmovable relative to the cord 10. Then, the lock module 20 is pushed toward the engaging seat 30. With reference to FIGS. 3 and 6, the sliding element 23 is moved downward such that the sliding element 231 can avoid interference of the stop segment 313 of the engaging seat 30, and then the engaging member 31 is mounted in the engaging opening 211a of the lock casing 21. With reference to FIGS. 3 and 7, when an external force applied on the sliding element 231 is removed, the resilient element 24 pushes the sliding element 23 to the original position. At this time, the stop segment 231 of the sliding element 23 abuts an inner wall of the stop segment 313 of the engaging seat 30, such that the lock module 20 cannot be separated from the engaging seat 30. Meanwhile, the assembling end 211 of the lock casing 21 abuts the pivot element 311 to make the pivot element 311 unable to rotate. Then, the lock core 22 is locked, such that the sliding element 23 is restricted by the actuating element 221 and is unmovable. Thus, the engaging seat 30 is fixed in position to make the portable electronic device tightly clamped between the engaging seat 30 and the mounting seat 40.

To release the locking status, the lock core 22 is unlocked first, and then the sliding element 23 is slid to release the abutment between the stop segment 231 of the sliding element 23 and the stop segment 313 of the engaging seat 30. Afterwards, the lock module 20 is separated from the engaging seat 30, and then the pivot element 311 is rotated to make the bottom end 311a separated from the cord 10. Thus, the engagement between the engaging seat 30 and the cord 10 is released, and the engaging seat 30 can be moved away from the mounting seat 40. Therefore, the portable electronic device is not clamped between the engaging seat 30 and the mounting seat 40, and can be separated from the pulling locking device.

Two sides of the portable electronic device are clamped between the engaging seat 30 and the mounting seat 40, and the cord 10 is fixed in position, such that the portable electronic device can be fixed in position as well to prevent theft.

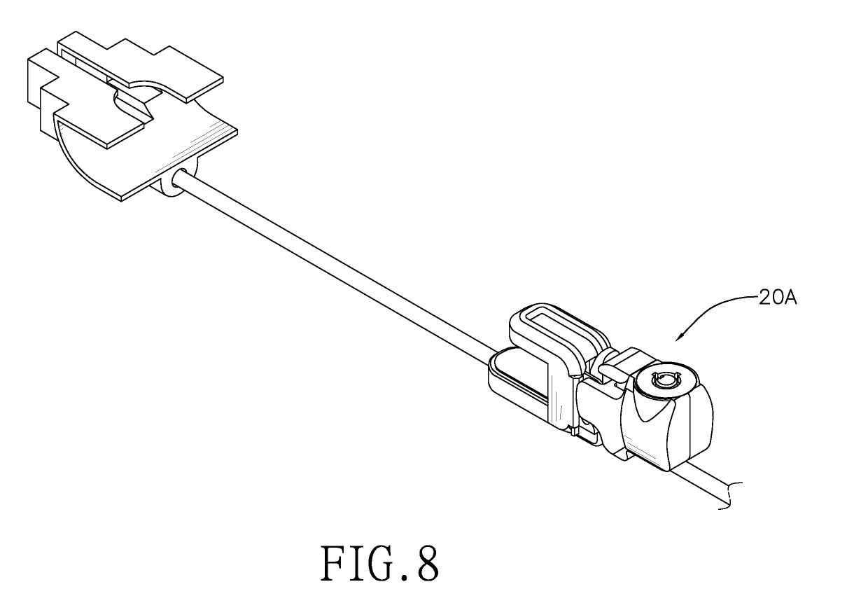

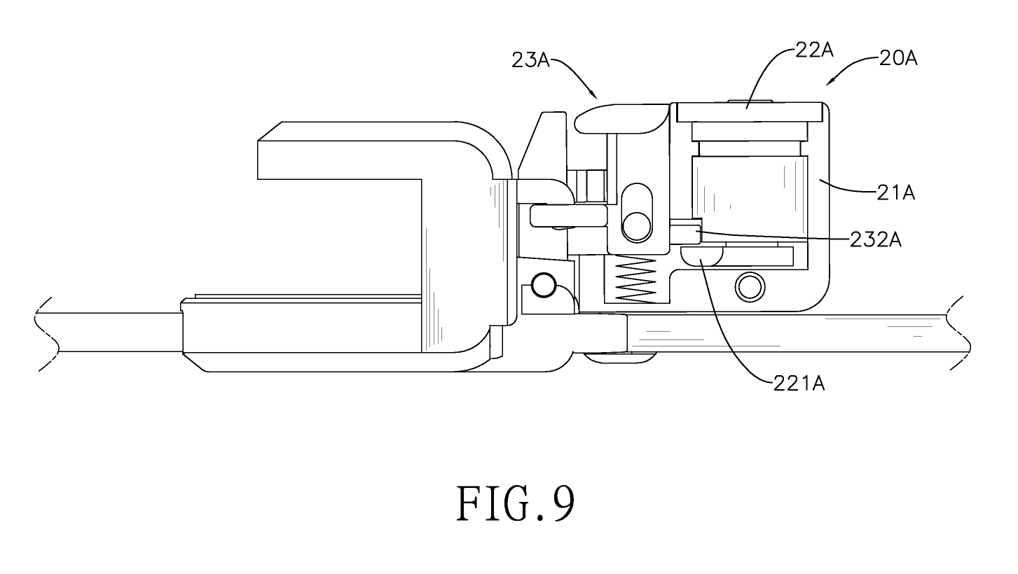

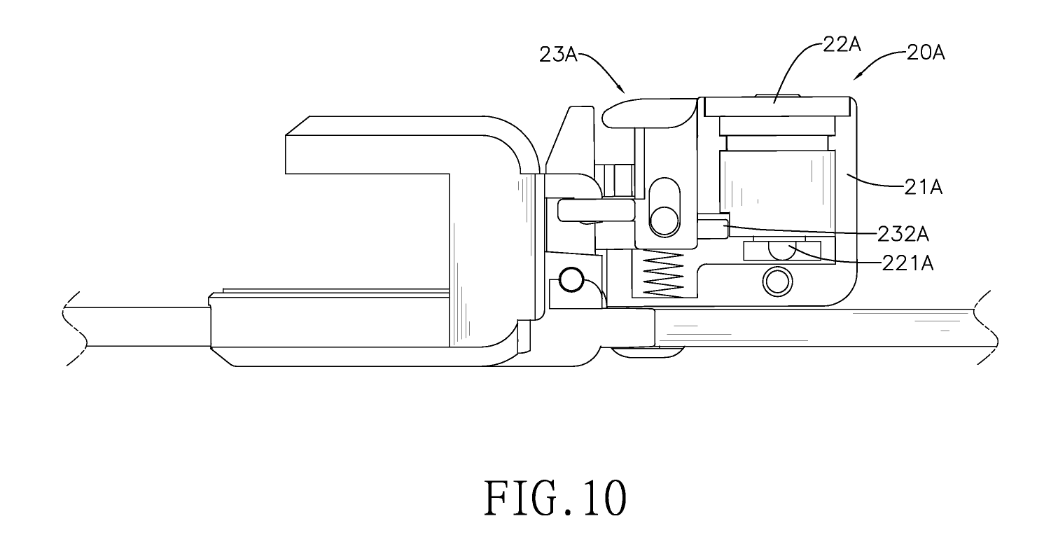

The lock core of the pulling locking device may be in various forms. In a preferred embodiment as shown in FIG. 2, the lock core 22 is a combination lock, and the actuating element 221 of the lock core 22 is a lock pin. When the lock core 22 is unlocked, the lock pin is axially moveable in the lock core 22, such that the sliding element 23 can axially move and push the lock pin, which means the sliding element 23 is not limited by the lock pin. When the lock core 22 is locked, the lock pin is unmovable, and thus can prevent the sliding element 23 from sliding. In another preferred embodiment as shown in FIGS. 8 to 10, the lock core 22A of the lock module 20A is a cam lock, and is mounted in the lock casing 21A. The actuating element 221A of the lock core 22A is a cam. When the lock core 22A is unlocked, the cam is away from the abutting segment 232A of the sliding element 23A, such that the sliding element 23A is not limited by the cam. When the lock core 22A is locked, the cam prevents the abutting segment 232A of the sliding element 23A from sliding.

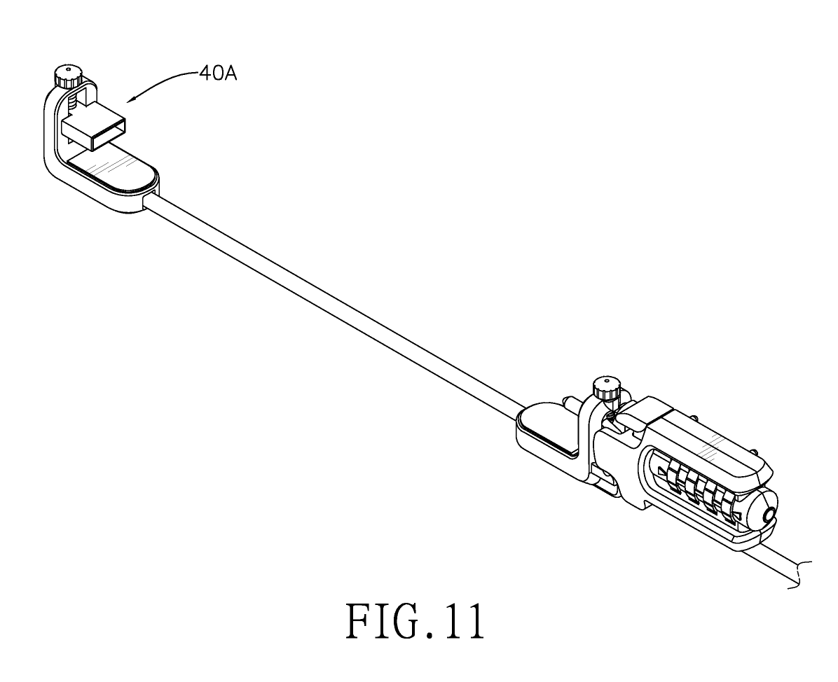

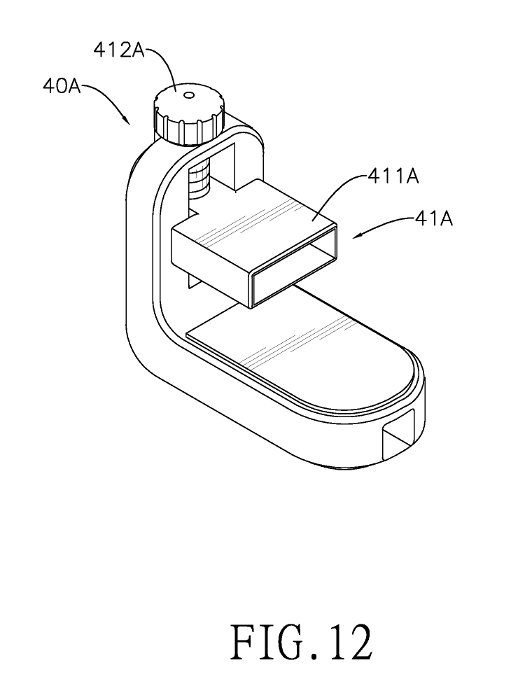

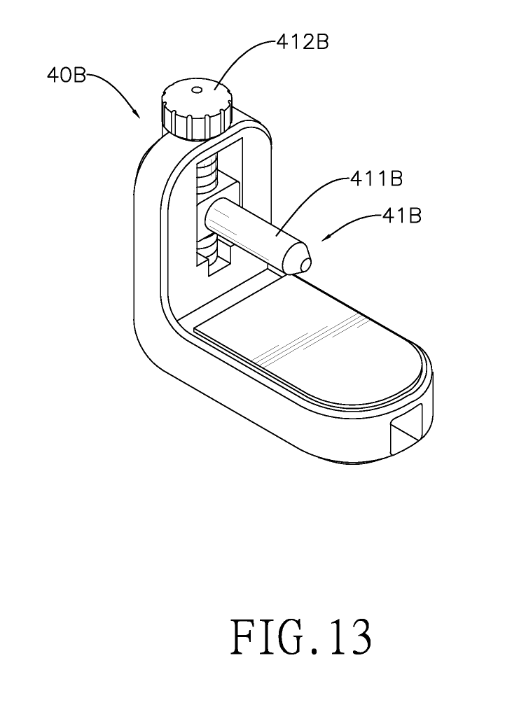

The mounting seat of the pulling locking device may be in various forms. In another preferred embodiment as shown in FIGS. 11 and 12, the clamp member 41A of the mounting seat 40A has a USB port connector 411A and an adjusting screw 412A. The adjusting screw 412A is mounted through and screwed with the USB port connector 411A to adjust the height of the USB port connector 411A. In still another preferred embodiment as shown in FIG. 13, the clamp member 41B of the mounting seat 40B has an earphone hole connector 411B and an adjusting screw 412B. The adjusting screw 412B is mounted through and screwed with the earphone hole connector 411B to adjust the height of the earphone hole connector 411B. The USB port connector 411A and the earphone hole connector 411B may be each respectively mounted in the USB port and the earphone hole of the portable electronic device to strengthen of the locking between the portable electronic device and the pulling locking device.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A pulling locking device comprising:
a cord;
a lock module mounted around the cord, and having
a lock casing mounted around the cord and having an assembling end;
a lock core mounted in the lock casing, and having an actuating element;
a sliding element selectively slidably mounted in the lock casing;
wherein when the lock core is locked, the actuating element abuts the sliding element to prevent the sliding element from sliding relative to the lock casing, and when the lock core is unlocked, the actuating element departs from the sliding element to make the sliding element slidable relative to the lock casing; and
a resilient element clamped between an inner wall of the lock casing and the sliding element;
an engaging seat mounted around the cord, disposed adjacent to the lock module, and having
a first side being toward the assembling end of the lock casing;
a second side;
an engaging member disposed on the first side of the engaging seat, selectively making the engaging seat engage with the cord, and selectively engaging with the sliding element of the lock module; and
a clamp member disposed on the second side of the engaging seat;
a mounting seat mounted around the cord, and having a clamp member; and
a cord hole disposed around the cord; and
a fixing nut mounted around and screwed on an end of the cord.

2. The pulling locking device as claimed in claim 1, wherein the lock casing of the lock module has
an engaging opening formed in the assembling end of the lock casing;
a mounting hole formed in the assembling end, uncommunicating with the engaging opening, and disposed around the cord; and
an inner space disposed adjacent to the assembling end and communicating with the engaging opening; the sliding element and the resilient element of the lock module mounted in the inner space.

3. The pulling locking device as claimed in claim 2, wherein
the sliding element has
an elongated hole formed in the sliding element; and
the lock casing of the lock module has
a positioning pin formed in the inner space of the lock casing and mounted in the elongated hole.

4. The pulling locking device as claimed in claim 2, wherein
the sliding element of the lock module has
a stop segment formed on an outer side of the sliding element and extending into the engaging opening of the lock casing; and
the engaging member of the engaging seat has
a stop segment corresponding to the stop segment of the sliding element.

5. The pulling locking device as claimed in claim 1, wherein the sliding element of the lock module has
an abutting segment formed on an inner side of the sliding element and selectively abutting the actuating element of the lock core.

6. The pulling locking device as claimed in claim 1, wherein
the engaging seat has
a cord hole disposed around the cord; and
the engaging member of the engaging seat has
a pivot element pivotally connected to the first side of the engaging seat, and having
a bottom end selectively extending to the cord hole of the engaging seat.

7. The pulling locking device as claimed in claim 2, wherein the engaging seat has
a mounting protrusion corresponding to the mounting hole of the lock casing.

8. The pulling locking device as claimed in claim 1, wherein the sliding element of the lock module has
a crown segment disposed on an end of the sliding element and protruding out of the lock casing.

9. The pulling locking device as claimed in claim 1, wherein
the cord hole of the mounting seat is a non-circular hole; and
the fixing nut is selectively mounted in the cord hole of the mounting seat, is a non-circular nut, and corresponds to the cord hole of the mounting seat in shape.

10. The pulling locking device as claimed in claim 1, wherein the lock core of the lock module is a combination lock, and the actuating element of the lock core is a lock pin.

11. The pulling locking device as claimed in claim 1, wherein the lock core of the lock module is a cam lock, and the actuating element of the lock core is a cam.

12. The pulling locking device as claimed in claim 1, wherein the clamp member of the mounting seat has
a USB port connector; and
an adjusting screw mounted through and screwed with the USB port connector to adjust the height of the USB port connector.

13. The pulling locking device as claimed in claim 1, wherein the clamp member of the mounting seat has
an earphone hole connector; and
an adjusting screw mounted through and screwed with the earphone hole connector to adjust the height of the earphone hole connector.
